(19) United States
(12) Patent Application Publication
(10) Pub. No.: US 2010/0295755 A1
(43) Pub. Date: Nov. 25, 2010

(54) DISPLAY

(76) Inventors: Benjamin John Broughton, Oxfordshire (GB); Nathan James Smith, Oxfordshire (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/446,256

(22) PCT Filed: Oct. 23, 2007
(86) PCT No.: PCT/JP2007/070977

§ 371 Date: Apr. 20, 2009

(30) Foreign Application Priority Data
Nov. 7, 2006 (GB) 0622109.7

(51) Int. Cl. G09G 3/00

(52) U.S. Cl. 345/32

(57) ABSTRACT

A display is provided having a public viewing mode and a private viewing mode. The display comprises a display device (11), such as an LCD, which directs image-modulated light towards the whole of a public viewing region. The display device (11) displays a first image in the public mode and second and third spatially interlaced images in the private mode. A controllable liquid crystal device (10) is switchable between the public and private modes. In the public mode, light modulated by the first image has a first polarisation. In the private mode, light modulated by the second and third images is provided with second and third polarisations, respectively. An optical arrangement, comprising an angularly dependent polarisation changer (9) and a polariser (8) permits the passage of light of the first polarisation into substantially the whole of the public region. Light of the second polarisation is substantially restricted to a private viewing region within the public region. Light of the third polarisation is substantially restricted into one or more non-private viewing regions outside the private region and within the public region.

### TECHNICAL FIELD

The present invention relates to a display having public and private viewing modes.

### BACKGROUND ART

Electronic display devices, such as monitors used with computers and screens built in to telephones and portable information devices, are usually designed to have a viewing angle as wide as possible, so that they can be read from any viewing position. However, there are some situations where a display that is visible from only a narrow range of angles is useful. For example, one might wish to read a private document using a portable computer while on a crowded train.

U.S. Pat. No. 6,552,850 (E. Dudasik; Citicorp Inc. 2003) describes a method for the display of private information on a cash dispensing machine. Light emitted by the machine's display has a fixed polarisation state, and the machine and its user are surrounded by a large screen of sheet polariser which absorbs light of that polarisation state but transmits the orthogonal state. Passers by can see the user and the machine but cannot see information displayed on the screen.

A versatile method for controlling the direction of light is a ‘louvred’ film. The film consists of alternating transparent and opaque layers in an arrangement similar to a Venetian blind. Like a Venetian blind, it allows light to pass through it when the light is travelling in a direction nearly parallel to the layers, but absorbs light travelling at large angles to the plane of the layers. These layers may be perpendicular to the surface of the film or at some other angle. Methods for the production of such films are described in a U.S. RE27617 (F. O. Olsen; 3M 1973), U.S. Pat. No. 4,766,023 (S.-L. Lu, 3M 1988), and U.S. Pat. No. 4,764,410 (R. F. Grzywinski; 3M 1988).

Other methods exist for making films with similar properties to the louvred film. These are described, for example, in U.S. Pat. No. 5,147,716 (P. A. Bellus; 3M 1992), and U.S. Pat. No. 5,528,319 (R. R. Austin; Photran Corp. 1996).

Louvre films may be placed either in front of a display panel or between a transmissive display and its backlight to restrict the range of angles from which the display can be viewed. In other words, they make a display “private”.

U.S. 2002/0158967 (J. M. Janick; IBM, published 2002) shows how a light control film can be mounted on a display so that the light control film can be moved over the front of the display to give a private mode, or mechanically retracted into a holder behind or beside the display to give a public mode. This method has the disadvantages that it contains moving parts which may fail or be damaged and that it adds bulk to the display.

A method for switching from public to private mode with no moving parts is to mount a light control film behind the display panel, and to place a diffuser which can be electronically switched on and off between the light control film and the panel. When the diffuser is inactive, the light control film restricts the range of viewing angles and the display is in private mode. When the diffuser is switched on, it causes light travelling at a wide range of angles to pass through the panel and the display is in public mode. It is also possible to mount the light control film in front of the panel and place the switchable diffuser in front of the light control film to achieve the same effect.

Switchable privacy devices of these types are described in U.S. Pat. No. 5,831,698 (S. W. Depp; IBM 1998), U.S. Pat. No. 6,211,930 (W. Sautter; NCR Corp. 2001) and U.S. Pat. No. 5,877,829 (M. Okamoto; Sharp K. K. 2001). They share the disadvantage that the light control film always absorbs a significant fraction of the light incident upon it, whether the display is in public or private mode. The display is therefore inefficient in its use of light. Since the diffuser spreads light through a wide range of angles in the public mode, these displays are also dimmer in public than in private mode, unless the backlight is made brighter to compensate.

Another disadvantage relates to the power consumption of these devices. In the public mode of operation, the diffuser is switched so as to be non-diffusing. This often means that voltage is applied to a switchable polymer-dispersed liquid crystal diffuser. More power is therefore consumed in the public mode than in the private mode. This is a disadvantage for displays which are used for most of the time in the public mode.

Another known method for making a switchable public/private display is given in U.S. Pat. No. 5,825,436 (K. R. Knight; NCR Corp. 1998). The light control device is similar in structure to the louvred film described earlier. However, each opaque element in the louvred film is replaced by a liquid crystal cell which can be electronically switched from an opaque state to a transparent state. The light control device is placed in front of or behind a display panel. When the cells are opaque, the display is in its private mode; when the cells are transparent, the display is in its public mode.

The first disadvantage of this method is in the difficulty and expense of manufacturing liquid crystal cells with an appropriate shape. A second disadvantage is that in the private mode, a ray of light may enter at an angle such that it passes first through the transparent material and then through part of a liquid crystal cell. Such a ray will not be completely absorbed by the liquid crystal cell and this may reduce the privacy of the device.

Another method for making a switchable public/private display device is given in JP3607272 and JP3607286 (Toshiba 2005). This device uses an additional liquid crystal panel, which is has patterned liquid crystal alignment. Different aligned segments of the panel modify the viewing characteristics of different areas of the display in different ways, with the result that the whole display panel is fully readable only from a central position.

GB2405544 describes switchable privacy devices based on louvres, which operate only for one polarisation of light. The louvres are switched on and off either by rotating dyed liquid crystal molecules in the louvre itself or by rotating the plane of polarisation of the incident light using a separate element.

In GB2413394, a switchable privacy device is constructed by adding one or more extra liquid crystal layers and polarisers to a display panel. The intrinsic viewing angle dependence of these extra elements can be changed by switching the liquid crystal electrically in the well-known way.

In GB2410116, a display is switched from public to private mode by using two different backlights which generate light with different angular ranges.

In GB2421346, a polarisation modifying layer (PML) is placed behind the exit polariser of a liquid crystal display panel. Some parts of the PML are simply transparent. Other parts change the polarisation of light passing through them so that pixels viewed through these parts are inverted in colour (bright pixels becoming dark and dark pixels becoming bright). Data sent to pixels directly behind these parts is inverted so that when the display is viewed from a central position, the image appears normally. However, when the display is viewed from a different angle, different pixels are viewed through the retarder elements and the image is corrupted. Off-axis viewers see a confusing image which is a random dot pattern. The PML may be made from liquid crystal and switched off to give a public mode.

GB2418518 adds a guest host (dyed) LC layer with a patterned electrode to a standard thin film transistor (TFT) LC display. The dyed LC layer can be switched between an absorbing (private) and non absorbing state (public). The dye molecule absorption is dependent upon the incident angle and polarisation of light. For a given polarisation and orientation the absorption of the dye increases with larger viewing angles resulting in low brightness at high angles (narrow mode).

GB patent application no. 0510422.9 discloses the combination of a privacy function and a three dimensional (3D) function provided by a single additional switch cell. The display has three operating states, a wide mode, a private mode and a 3D mode. Both patterned and unpatterned LC alignment embodiments are described.

GB patent application no. 0511536.5 discloses the use of an extra liquid crystal layer located between the existing polarisers of a liquid crystal display (LCD) panel. In this location, the extra switch cell can modify the greyscale curves for off axis light. This provides a higher level of privacy for images than the techniques disclosed in GB2413394.

GB patent application no. 0613462.1 discloses the use a switchable privacy device constructed by adding an extra cholesteric layer and circular polarisers to a display panel. The cholesteric layer can be switched between a public (wide view) mode and a private (narrow view) mode that can provide 360° azimuthal privacy.

Adachi et al (SID06, pp. 228) and Okumura (US20050190329) disclose the use of a HAN cell to provide a switchable privacy function. The HAN cells used by Adachi and Okumura are used in conjunction with an underlying image panel. The public (wide view) modes described by Adachi et al (SID06, pp. 228) and Okumura (US20050190329) are untwisted.

JP09230377 and US5844640 describe a method of changing the viewing angle properties of a single layer LCD panel. This is achieved for a Vertically Aligned Nematic (VAN) LC mode. Electric fields in the plane of the display panel are used to control how the LC material tilts in a pixel area. The number and orientation of different tilt domains within a pixel can be controlled by the in-plane fields. A pixel with several tilt domains will have a wide viewing angle, a pixel with one tilt domain will have a narrower viewing angle. The use of this method to vary the viewing angle of a display is described. However the viewing angle of a single tilt domain of the VAN mode described is not sufficiently narrow to provide good privacy.

GB2405516, GB2405518 and GB2405517 disclose liquid crystal display modes which have inherently asymmetric viewing angle in order to make an image viewable from a particular direction only. Such displays use a plurality of pixel types with different viewing directions to provide multiple view displays, which can be switched to a single wide-view display by using a switchable diffuser.

### DISCLOSURE OF INVENTION

According to the invention, there is provided a display having a public viewing mode and a private viewing mode and comprising: a display device arranged to direct image-modulated light towards the whole of a public viewing region and arranged to display a first image in the public mode and second and third spatially interlaced images in the private mode; a controllable liquid crystal device which is switchable between the public mode, in which light modulated by the first image has a first polarisation, and a private mode, in which light modulated by the second and third images is provided with second and third polarisations, respectively; and an optical arrangement which comprises an angularly dependent polarisation changer and a polariser, which permits the passage of light of the first polarisation into substantially the whole of the public region, which restricts the passage of light of the second polarisation substantially only into a private viewing region within the public region, and which restricts the passage of light of the third polarisation substantially only into at least one non-private viewing region outside the private region and within the public region.

The private region may be on and round an axis of the display. The at least one non-private region may comprise a plurality of regions disposed away from the display axis.

The first polarisation may be substantially the same as one of the second and third polarisations.

The combination of the controllable device in the public mode and the optical arrangement may have substantially no effect on the first polarisation.

The third polarisation may be substantially orthogonal to the second polarisation.

The first, second and third polarisations may be substantially linear polarisations.

The polarisation changer may comprise a retarder. The retarder may comprise a negative C plate. The retarder may have a retardation which substantially compensates for retardation of the controllable device in the public mode.

The controllable device may have first and second sets of regions optically aligned with first and second sets of pixels of the display device for displaying the second and third images, respectively, the first and second sets of regions having different polarisation-changing effects in the private mode. The regions of one of the first and second sets may be arranged to change the polarisation of light passing therethrough by 90° in the private mode. The regions of the one set may be arranged to operate in the twisted nematic mode during operation in the private mode. The regions of the other of the first and second sets may be arranged to have substantially no effect on the polarisation of light passing therethrough in the private mode. The regions of the other set may be arranged to operate in the electrally controlled birefringence mode during operation in the private mode. The controllable device may be arranged to operate with homeotropic alignment in the public mode.

The controllable device may be of the splay-twist type and may have a patterned electrode arrangement defining the regions of the first and second sets.

The display device may be a liquid crystal display device. The display device may be transmissive. The display may comprise a backlight for the display device.

The display device may comprise a light emitting diode display device. The display device may be an organic light emitting diode display device.

The third image may comprise an obscuring image or sequence of images for obscuring the second image in viewing regions receiving light from the second and third images during the private mode.

It is thus possible to provide a display having public and private viewing modes such that, in the private viewing mode, the image displayed outside the private viewing region can be controlled and selected as desired. Such a display need be no thicker than known types of displays which are switchable between public and private viewing modes. Such an arrangement allows colour images, animations, video and the like to be displayed in the non-private viewing regions, thus allowing users to customise such “side images”. For example, telephone manufactures and network operators may display advertising images in the non-private viewing regions and confidential information may be displayed while “protecting side images” may simultaneously be displayed so as to make it non-obvious that a display is in the private viewing mode. Full image display resolution is available for the public viewing mode. Manufacturing problems associated with aligning parallax optics with display devices are avoided.

### BRIEF DESCRIPTION OF DRAWINGS

FIG. 1 is a diagram illustrating a private viewing mode of a display constituting an embodiment of the invention;

FIG. 2 is a cross-sectional drawing of a display constituting an embodiment of the invention and operating in a private viewing mode;

FIG. 3 is a cross-sectional view of the display of FIG. 2 illustrating operation in a public viewing mode;

FIGS. 4(a) and 4(b) illustrate the result of modelling the optical performance of a display of the type shown in FIGS. 2 and 3;

FIG. 5 is a graph of luminescence in arbitrary units against polar viewing angle in degrees illustrating performance in the public and private viewing modes;

FIG. 6 is a diagrammatic cross-sectional view illustrating in more detail the operation of the display shown in FIGS. 2 and 3;

FIG. 7 is a diagrammatic cross-sectional view of a splay-twist mode liquid crystal device which may be used in the display shown in FIGS. 2 and 3; and

FIGS. 8(a) and 8(b) are diagrammatic cross-sectional views of another type of liquid crystal device which may be used in the display shown in FIGS. 2 and 3.

Like reference numerals refer to like parts throughout the drawings.

### BEST MODE FOR CARRYING OUT THE INVENTION

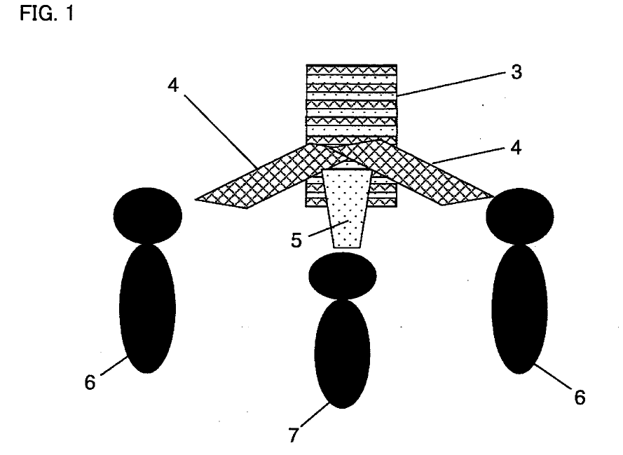

FIG. 1 illustrates an interlaced image display 3, in which light emitted by alternate pixel rows has an orthogonal polarisation state to that emitted by the remaining pixel rows, and in which the two images, composed of one polarisation state each, are separated to a “main” or private viewing region 5 containing a viewer 7 and “side” or non-private viewing regions 4 containing viewers 6.

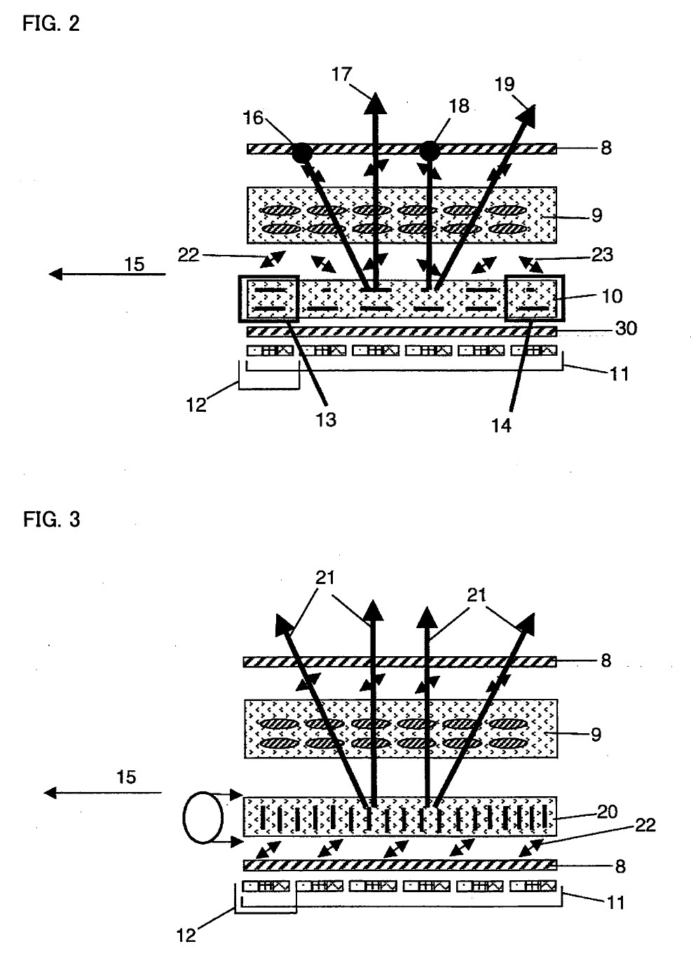

FIG. 2 shows a display constituting a preferred embodiment of the invention operating in the private mode. The polarisation state of the rays at several points through the stack is illustrated with a tilted arrow indicating a linear polarisation at either +45° (22) or −45° (23) to the vertical direction 15, depending on the tilt of the arrow. The change in polarisation state of the rays propagating at an angle to the display axis caused by a negative dielectric anisotropy (Δε) retarder 9 occurs for rays at similar angles into and out of the page, as well as for those shown.

An LCD display panel 11 is shown which has a wide viewing angle and comprises sets of red, green and blue pixel display elements 12. An additional liquid crystal cell 10 is positioned over the display panel such that the patterned alignment regions 13, 14 of the additional cell are in registration with the pixel rows 12 of the display. The additional cell is patterned in its liquid crystal configuration such that the output polarisation state of the light from alternate rows of the display panel is rotated by 90°. To produce this effect, the liquid crystal cell comprises alternating regions of twisted nematic (TN) mode and untwisted mode liquid crystal configuration, the spatial frequency (pitch) of the alternating regions being twice the pixel pitch of the underlying display panel. The remaining rows are left unchanged in this polarisation state. A layer of negative optical anisotropy retarder film (−ve C plate) 9 is positioned over the additional liquid crystal cell, and an additional polarisation sheet 8 is positioned over the −ve C plate 9 such that its transmission axis is parallel to the transmission axis of the output polariser 30 of the display panel. In order for the secondary image to be displayed to viewers horizontally to the side of the display 6, as in FIG. 1, these transmission axes are at +/−45° to the vertical 15 in the normal orientation of the display.

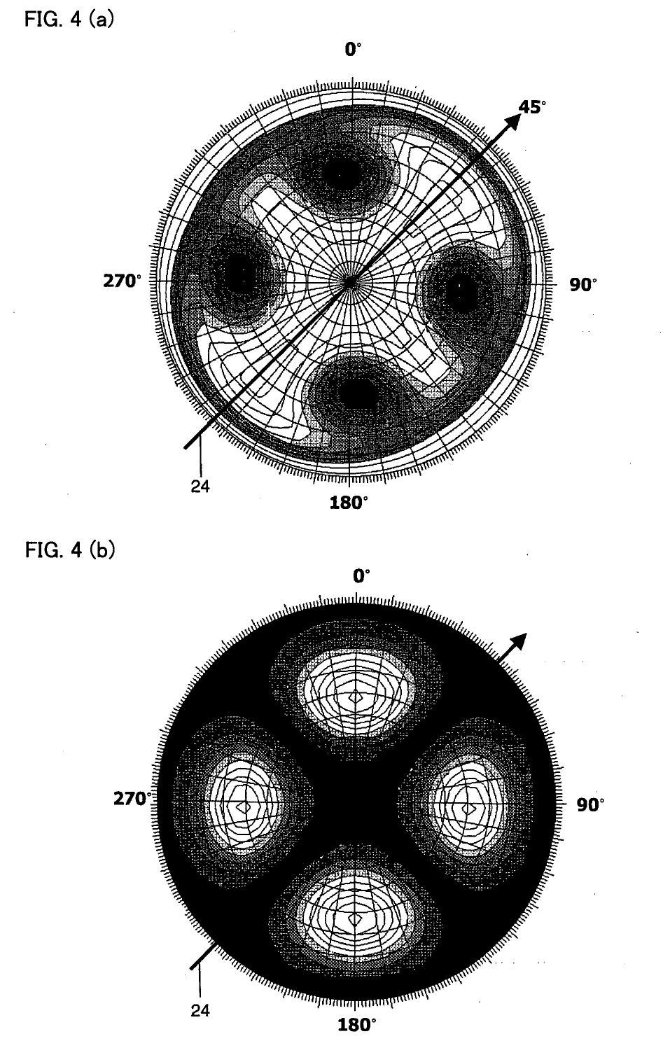

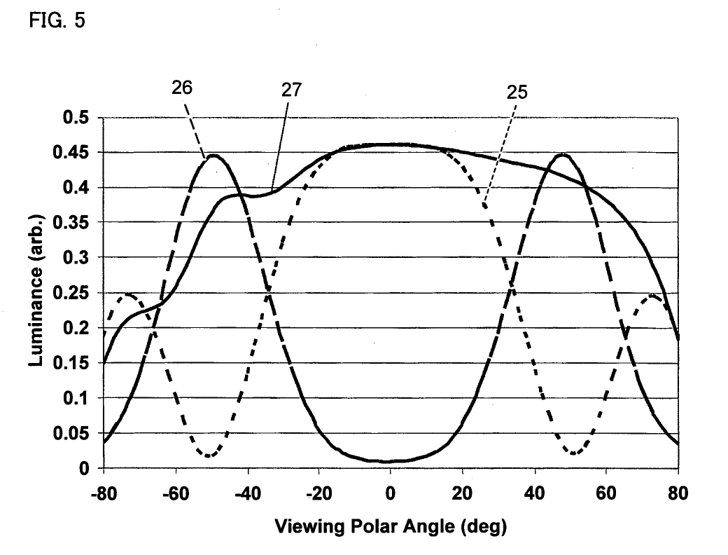

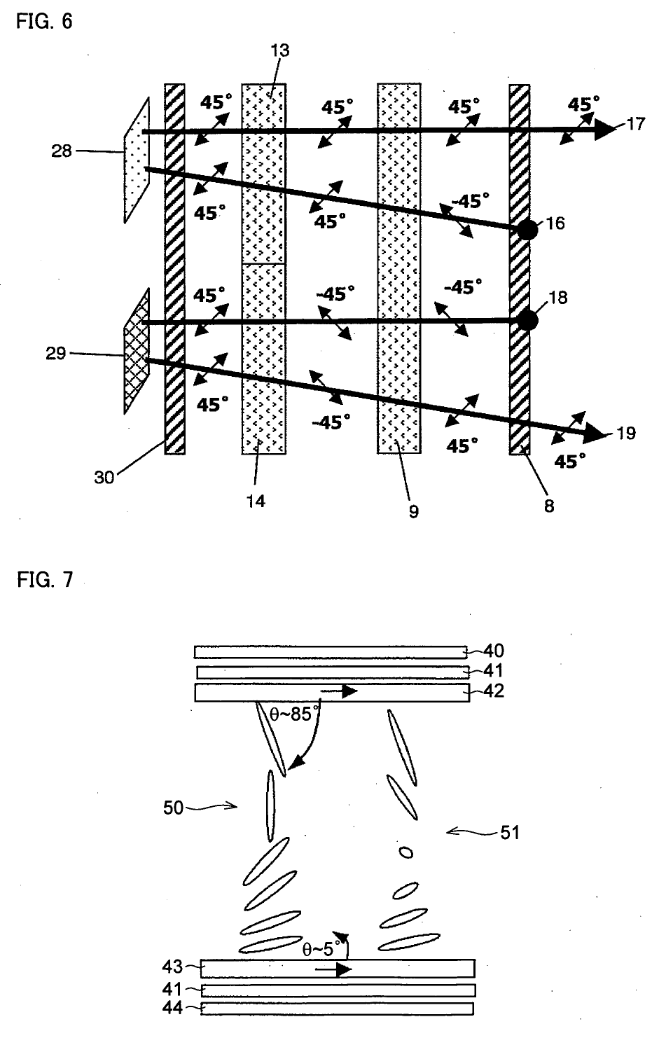

The effect of the patterned additional liquid crystal cell 10 is to rotate the polarisation state of the light which comprises the secondary image by 90° (i.e. from +45° to −45°, as shown in FIGS. 2 and 6), while leaving the primary image unaffected. The effect of the −ve C plate 9 is to leave these polarisation states unaffected for rays 17, 18 propagating on-axis (orthogonally to the layer) to the main viewer 7, but to rotate both polarisation states by 90° for rays 16, 19 travelling off-axis towards side viewers 6. The additional polariser 8 therefore absorbs light from the secondary image which is propagating on-axis as this light has had its polarisation state rotated by the additional liquid crystal cell 10 to be orthogonal to the polariser 8 transmission axis. The light comprising the main image however still has its polarisation state parallel to the transmission axis and hence passes through the polariser 8 to form the main image to the main viewer 7. The inverse occurs for off axis rays, as the light from both sets of images now has its polarisation state rotated by 90° by the negative C plate layer 9. The main image is therefore blocked and the secondary image is transmitted to form the displayed image to the side viewer 6. The effect is shown in FIGS. 4(a) and 4(b), the polar plots in which illustrate the modelled relative brightness as a function of viewing angle for the main image at (a) and the side images at (b). FIG. 5 shows the cross-section of these plots in the horizontal plane (90° azimuth as indicated in FIGS. 4(a) and 4(b)) to illustrate the privacy performance. Brightness of the main image is shown at 25, of the side images at 26, and of the public mode image at 27.

In the public mode, as shown in FIG. 3, an electric field is applied to the additional liquid crystal cell 20 causing the liquid crystal director to rotate to align with the applied field direction. This prevents any rotation of the polarisation state of the light emitted by the display panel, as the twist in the liquid crystal layer is removed, and the liquid crystal cell is designed to have an overall retardation which is positive and compensates for the −ve C plate layer 9. The liquid crystal cell 20 and the −ve C plate 9 combined now appear optically neutral and the light from all regions of the display panel 11 is transmitted to all viewers. The display panel now need not show an interlaced image, and a single full resolution image can be displayed with full brightness.

In a specific example of the display, the −ve C plate layer has an overall optical retardation in the region of 800-1000 nm. This ensures the secondary image becomes dominant at the desired angle of 40° to 50° from the normal to the display. The additional liquid crystal cell 10 has a liquid crystal layer thickness in the region of 12-17 μm to allow the portions 14 of the cell which are in the twisted state at 0V to operate at or near the Gooch-Tarry 2^{nd} minimum for twisted nematic cells. This maximises the efficiency of the cell at blocking the secondary image to the main viewer. The Δε of the liquid crystal used is chosen to fulfil this 2^{nd} minimum condition for the cell thickness used while in the 0V state, and also to compensate for the retarder film when in the switched state 20 at approximately 5V. This embodiment also has the alignment patterned so that the twisted portions 14 of the cell are positioned over alternate pixel rows 12, as opposed to columns, of the underlying display panel. The alignment layers of the cell are rubbed at 45° and −45° (relative to the vertical 15 in the orientation in which the display is normally viewed, see FIGS. 4(a) and 4(b)) in the twisted sections to create a TN mode, and at 45° and 225° in the untwisted portions 13 to create an antiparallel aligned ECB (electrically controlled birefringence) mode. These rubbing directions are all either parallel or perpendicular to the polariser 30, 8 transmission axes.

Patterning the additional liquid crystal cell 10 such that the polarisation state of alternate pixel rows, not columns, is rotated has the advantage that, in the horizontal viewing plane which is the preferred plane for the privacy effect to be most pronounced, the privacy is provided solely by the −ve C plate layer 9 and no parallax problem occurs between the underlying display panel 11 and the patterned additional liquid crystal cell 10. To the off axis viewer in the vertical plane, the pixel rows of the display panel 11 and the patterning of the additional liquid crystal cell 10 may not be exactly aligned, so a parallax error occurs. This can be used to the advantage of the privacy mechanism however, as the parallax can be designed to cause the secondary image to be displayed to the vertically off-axis viewer at a narrower angle than the −ve C plate 9 causes this effect.

On the other hand, a thin glass layer can be used between the display panel 11 and the additional liquid crystal cell 10 to reduce the parallax problem and allow both horizontal and vertical privacy to be determined by the retardation of the −ve C plate 9.

In fact, the thickness of the glass and glue layers between the LCD image panel 11 and the LC layer of the additional switch cell 10 may be such that, as the viewing angle increases in the vertical direction, the parallax effect causes first the secondary image to become visible, then the primary image again as the inclination angle increases further. This ‘second window’ for the primary image can be made to coincide with the angle at which the optical retardation of the negative C plate 9 causes the observed image to be reversed. In this way, the ‘second window’ of the primary image can be eliminated, causing the secondary image to be visible at all viewing angles in the vertical direction greater than the initial parallax cut-off for the primary image.

Also the −ye C plate 9 used need not be exactly that. Any optical layer which leaves the polarisation state of the light propagating normal to the layer (on-axis) unaffected while applying a retardation or otherwise rotating the polarisation state of light propagating at an angle through the layer can be used. An example of a layer which could achieve this would be another uniform aligned liquid crystal cell in the ECB mode with an intermediate voltage applied or a cell with a chiral liquid crystal mode such as that disclosed in GB patent application no. 0613462.1. Other examples include a polymer liquid crystal layer with the desired properties, such as a highly chiral reactive mesogen layer. In fact the use of an ECB cell or a fixed tilted optical retarder (optic axis at some angle non-parallel and non-normal to the layer) would affect the polarisation state of light propagating off-axis only in the horizontal plane. This would allow the image viewing regions in the horizontal plane to be controlled solely by the tilted retarder layer, while the viewing regions for the two images in the vertical plane would be controlled solely by the parallax effect due to the separation between the display panel and additional liquid crystal cell.

Due to the need to interlace the two images in the private mode, each image has its resolution reduced by half in one direction (e.g. a 240×320 pixel display can only display two interlaced images of 240×160 pixels each). To mitigate this, display panels can be manufactured with doubled resolution in the required direction.

The additional liquid crystal cell 10 is constructed substantially as follows. Two glass substrates contain the additional liquid crystal layer. The thickness of the glass is not important except for the fact that it may determine the distance between the underlying LCD image panel 11 and the additional liquid crystal layer 10, in which case it will determine the angle at which the parallax effect between these two layers affects the viewing regions in the vertical viewing direction. To this end, thin glass is preferred to reduce the parallax effect. The glass substrates are coated with a layer of transparent electrical conducting material such as ITO (indium tin oxide). The substrates are then further coated with a polymer alignment layer which promotes alignment of the adjacent liquid crystal layer in a direction parallel to the glass surface (planar alignment).

On the substrate which will sit closest to the underlying LCD display, the alignment layer is mechanically rubbed uniformly at an angle of 45° to the vertical viewing direction 15, such that it will promote alignment of the liquid crystal in this direction, causing the optic axis of the positive uniaxial liquid crystal material used to lie parallel to the transmission axis of the output polariser 30 of the display panel.

On the substrate which will sit furthest from the underlying LCD panel, the alignment layer is first rubbed uniformly in a direction antiparallel to the opposing substrate, but is then subjected to a multirubbing process as described in EP 0887667, in which a photoresist layer, such as Shipley PLC's Mircoposit S1805, is deposited on the alignment layer, selectively exposed to UV light through a mask, and developed. The substrate is then rubbed a second time at an orthogonal angle (−45°) to the original rubbing direction causing the regions not protected by the remaining photoresist to have their alignment direction reoriented in this direction. The remaining photoresist is then exposed to UV light and developed. The mask used for the exposure is chosen to produce a pattern of alignment directions on the substrate which matches alternate pixel rows 12 (or groups of rows) on the underlying LCD panel.

In addition to the multirubbing method, a range of other techniques can be used to produce the required patterning of the regions in the additional liquid crystal cell which alternate between regions which leave the polarisation state of light propagating through the layer unaffected and the regions which rotate it by 90°. These include photoalignment or patterning of the ITO electrodes in combination with a suitable liquid crystal mode such as the splay-twist mode described hereinafter.

The substrates are then showered with spacer beads and glued together with their alignment layers facing inwards and filled with liquid crystal. The diameter of the spacer beads determines the thickness of the liquid crystal layer and this is chosen in combination with the refractive index of the liquid crystal so that the optical retardation of the liquid crystal layer (Δnd) substantially matches that of the negative C plate 9 used above the additional liquid crystal cell 10, and also fulfils a Gooch-Tarry minimum condition for effective rotation for the polarisation state of light.

The retardation of the negative C plate 9 determines the polar angle from the on-axis direction at which 90° rotation of the polarisation state of the light propagating through the layer occurs, and hence the main image from the LCD panel is fully blocked, while the secondary image is fully transmitted. A retardation of the negative C plate of 880 nm is found to produce the required effect at the desired viewing angle of 50°. This is achieved by laminating eight of Nitto Denko's 110 nm negative C plate films to the outside of the additional cell furthest from the LCD panel. A thickness of 16.5 μm of Merck liquid crystal ZLI-4619-000, which has a birefringence of Δn=0.092 is then found to give good performance, both in compensating the negative C plate when in the switched state 20 to prevent any polarisation rotation through the combined LC/−ve C plate and produce a full brightness, full resolution public mode for the display, and also in rotating as much of the light as possible from the secondary image pixels by 90° when in the unswitched state, being near the Gooch-Tarry 2^{nd} minimum for twisted liquid crystal modes.

The additional liquid crystal cell, once constructed as outlined above, has the polariser film 8 laminated onto the outside of the substate furthest from the underlying image display panel 11 with transmission axes parallel to the output polariser 30 of the display panel, both being at 45° to the vertical viewing direction 15. It is then glued onto the front of the underlying LCD panel with the patterned alignment regions 13, 14 in registration with the pixel rows 12 of the LCD panel, to produce the stack as shown in FIG. 2.

FIG. 7 shows an alternative type of uniformly aligned liquid crystal device which may be used as the cell 10 in the display shown in FIGS. 2 and 3. This device is of the “splay-twist mode” type and comprises transparent substrates 40 and 44, for example made of glass, provided with transparent electrode arrangements 41, for example made of indium tin oxide (ITO). The upper substrate 40 is provided with an alignment layer 42 for promoting a high pre-tilt alignment but not a vertical (homeotropic) alignment. Thus, the pretilt θ is less than 90° and is greater than 45° but typically in the range above 75° and below 90°. A typical pre-tilt is approximately 85°. The alignment layer 42 is made of a material which is typically used to promote vertical alignment in its unrubbed state but is rubbed during alignment so as to provide a non-vertical pre-tilt. An example of such a material is known as JALS 2017 available from JSR.

The lower substrate is provided with an alignment layer 43 for promoting a lower pretilt which is greater than 0° but less than 40°. The pretilt is typically in the range above 0° and below 15° and an example of a suitable pretilt is 5°. The alignment layer 43 may, for example, comprise a material known as SE610 available from Nissan Chemicals and is rubbed in the direction indicated by the arrow.

The device is formed by assembling the substrates so as to provide a cell which is filled with a suitable liquid crystal material. The substrates are aligned such that the rubbing directions of the alignments layers 42 and 43 are parallel and point in the same direction. In other words, the pretilts at the alignment surfaces have components parallel to the alignment surfaces which point in the same directions. Once the device has been assembled, the resulting cell between the alignment layers 42 and 43 is filled with a nematic liquid crystal material. The liquid crystal material thus forms a layer between the alignment layers 42 and 43 with a director configuration determined by the alignment layers and by any applied electric field between the electrode arrangements 41.

Upon filling such a splay-twist cell, a mixture of two deformation states is observed. It is believed that these are a splay-bend deformation and a splay deformation. The splay deformation and the splay-bend deformation are topologically distinct as disclosed by Wang and Bos, J. Appl. Phys., Vol. 90, pp 552 (2001). The splay-bend deformation shown at 50 has a director that passes through vertical near the “high pretilt” substrate 40 whereas the splay deformation, to the best of our knowledge, has a director profile that passes through a horizontal position near the “low pretilt” substrate 44. The splay mode has no practical use in the applications described here. By application of a suitable out-of-plane electric field, the splay-bend deformation state 50 is nucleated over the entire display area and remains stable with no field applied i.e. the splay deformation is completely removed. (All electric fields discussed herein are out-of-plane electric fields, i.e. in a direction substantially perpendicular to the substrate).

The splay-twist cell may be filled with an LC that has negative dielectric anisotropy or positive dielectric anisotropy. A negative dielectric anisotropy material enables good control over a public (wide view) mode but offers poor control over the private (narrow view) mode. A positive dielectric anisotropy material enables good control over a private (narrow view) mode but offers poor control over the public (wide view) mode. Optimal performance may be found when the splay-twist cell is filled with a dual frequency LC material, for example MDA-00-3969 available from Merck. A dual frequency LC has a positive dielectric anisotropy for a given driving frequency range (usually low frequencies <1 kHz) and a negative dielectric anisotropy for a different given driving frequency range (usually high frequencies >10 kHz). Therefore a splay-twist cell filled with a dual frequency LC enables good control over both the private (narrow view) mode and the public (wide view) mode.

The application of an electric field can be used to switch between the splay-bend deformation 50 and a splay-twist deformation 51. When the splay-twist cell is arranged between parallel linear polarisers with the substrate rubbing direction either parallel or perpendicular to the transmission axes of the polarisers, three distinctly useful optical regimes can be realised.

Optical Regime 1: by application of a suitable large out-of-plane electric field, the bulk of the LC director aligns perpendicular to the electric field and parallel to the substrate plane. A combination of the rubbed alignment conditions and the appropriate electric field forces the director to adopt a splay-twist deformation 51. The director forms a twisted structure from the low pretilt substrate 44 to the high pretilt substrate 40. If the LC layer is thick enough (>˜10 μm) to satisfy the Mauguin guiding condition, then the polarisation state of the light entering the splay-twist mode has the same polarisation state as the light exiting from the splay-twist mode. This optical effect is equivalent to the ECB mode described above. If the LC layer is too thin to satisfy the Mauguin guiding condition, then the Gooch-Tarry guiding criteria (Gooch and Tarry, J. Phys. D., Vol. 8, pp 1575 to 1584 (1975)), can be employed to ensure that light entering the splay-twist mode 7 has the same polarisation state as the light exiting from the splay-twist mode.

Optical Regime 2: by application of a suitable out-of-plane electric field that is smaller than the electric field applied in Optical Regime 1, a smaller proportion of the director structure aligns perpendicular to the electric field (parallel to the substrate plane). A combination of the rubbed alignment conditions and the electric field still force the director to adopt a splay-twist deformation 51. Although the director is still twisted from the low pretilt substrate 44 to the high pretilt substrate 40, because the applied voltage is smaller than in Optical Regime 1, a large proportion of the LC layer has a high tilt. The optical effect is that light propagating largely on-axis is converted to the orthogonal polarisation state. This optical regime is equivalent to the

TN operation described above. Consequently the cell appears black between parallel polarisers. By appropriate patterning of the electrodes in the splay-twist cell, alternate rows (or alternate columns) of Optical Regime 1 and Optical Regime 2 can be realised. Since Optical Regime 2 appears black on-axis while Optical Regime 1 appears transparent, a parallax barrier can be realised.

In a suitably chirally doped LC cell, Optical Regime 2 can be configured to occur at no applied field. This will occur with a d/p (cell thickness divided by chiral pitch) ratio ˜0.3.

Optical Regime 3: By application of a suitable out-of-plane electric field across the entire splay-twist cell, the director structure aligns substantially parallel to the applied electric field. This provides the public viewing mode because the splay-twist cell and the negative C plate substantially compensate each other optically, i.e. the optical function of the splay-twist cell is “negated” for substantially all angles of incidence by the negative C plate.

It is not possible simultaneously to optimise all three optical regimes. However, good all round optical performance using reasonably low drive voltages (<20 V) can be obtained with the following parameters:

A cell that has a thickness of ˜40 μm,

High pretilt alignment layer inducing a pretilt of ˜85°;

Low pretilt alignment layer inducing a pretilt of ˜5°;

Dual frequency LC;

Chiral dopant with a cell thickness to pitch (d/p) ratio of ˜0.1

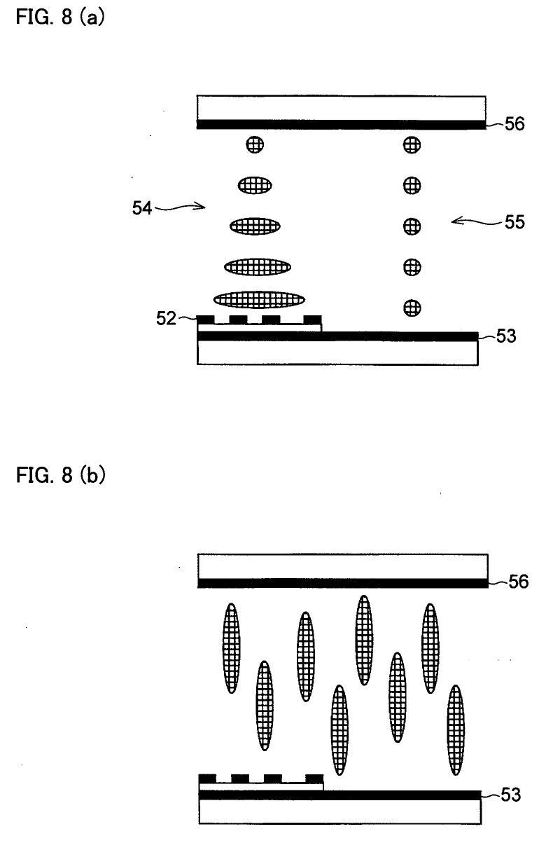

FIGS. 8(a) and 8(b) show a further alternate type of additional switch cell 10 which does not require patterned alignment. In this embodiment, both substrates of the additional switch cell have uniform planar LC alignment. A patterned electrode 52 is used on one of the cell substrates to produce IPS type (App. Phys. Lett, 67. pp 3895) or FFS type (SID '01 Digest pp 484) in-plane switching which rotates the

LC orientation in the plane of the cell to create a twisted LC structure 54. Regions of this type are alternated with plane electrode 53 regions resulting in alternating regions of TN like and ECB LC structure equivalent to the patterned alignment regions 13, 14 of the previously described switch cell 10, as shown in FIG. 2. In this condition, the additional switch cell with the alternate LC structure regions aligned with alternate pixel rows of the image panel 11 rotates the polarisation of light output from alternative pixel rows of the image panel and the device operates in the private mode as previously described. In the public mode as shown in FIG. 8 b, a voltage is applied between the plane electrodes 53, 56 on the opposing substrates of the additional cell and the LC aligns vertically in the cell so that its operation is equivalent to the public mode described previously and illustrated in FIG. 3.

Devices of this type may, for example, be applied to apparatuses where a user may wish to view confidential information but cannot control who else may be watching. Examples are personal digital assistants (PDAs), laptop personal computers (PCs), desktop monitors, automatic teller machines (ATMs) and electronic point of sale (EPOS) equipment.

As mentioned hereinbefore, the “side images” displayed by the display may be selected for advertising or distracting purposes. However, these side images may also be selected for their image-obscuring properties. For example, there is a limited angular viewing region into which some light from both images is transmitted and the side images may be selected or customised so as to obscure the main image in order to provide increased privacy in such regions. Suitable images for obscuring information onto which they are superimposed include optical illusion patterns, white noise and randomised patterns with a similar spatial frequency to the underlying information. For obscuring text, confusing randomised text may be used. Such obscuring images may be scalable so as to maximise their effectiveness and may be customised or changed to fit the content to be disguised or obscured.

In a further embodiment, an emissive type display such as an LED display or organic LED (OLED) display is used rather than an the LCD image panel 11. In this case, the device is still as illustrated in FIGS. 2 and 3 and the additional switch cell remains as described above; only the type of display on which the additional components are placed is changed. In fact the, device can operate in the manner described with any type of image display apparatus replacing the LCD image panel 11 which is capable of displaying primary and secondary images interlaced row-wise in the private mode and a single image in the public mode. Display types such as OLED do not inherently produce polarised light, which the device requires to allow separation of the two images to the separate viewers in the private mode. However, a polariser can simply be placed in front of the emissive type display at the expense of overall brightness. In fact, many OLED type displays use a front polariser to reduce ambient light reflection from the display, in which case the device could be incorporated without loss of image brightness from the underlying display.

1. A display having a public viewing mode and a private viewing mode and comprising: a display device arranged to direct image-modulated light towards the whole of a public viewing region and arranged to display a first image in the public mode and second and third spatially interlaced images in the private mode; a controllable liquid crystal device which is switchable between the public mode, in which light modulated by the first image has a first polarisation, and a private mode, in which light modulated by the second and third images is provided with second and third polarisations, respectively; and an optical arrangement which comprises an angularly dependent polarisation changer and a polariser, which permits the passage of light of the first polarisation into substantially the whole of the public region, which restricts the passage of light of the second polarisation substantially only into a private viewing region within the public region, and which restricts the passage of light of the third polarisation substantially only into at least one non-private viewing region outside the private region and within the public region.

2. A display as claimed in claim 1, in which the private region is on and round an axis of the display.

3. A display as claimed in claim 2, in which the at least one non-private region comprises a plurality of regions disposed away from the display axis.

4. A display as claimed in claim 1, in which the first polarisation is substantially the same as one of the second and third polarisations.

5. A display as claimed in claim 1, in which the combination of the controllable device in the public mode and the optical arrangement has substantially no effect on the first polarisation.

6. A display as claimed in claim 1, in which the third polarisation is substantially orthogonal to the second polarisation.

7. A display as claimed in claim 1, in which the first, second and third polarisations are substantially linear polarisations.

8. A display as claimed in claim 1, in which the polarisation changer comprises a retarder.

9. A display as claimed in claim 8, in which the retarder comprises a negative C plate.

10. A display as claimed in claim 8, in which the retarder has a retardation which substantially compensates for retardation of the controllable device in the public mode.

11. A display as claimed in claim 1, in which the controllable device has first and second sets of regions optically aligned with first and second sets of pixels of the display device for displaying the second and third images, respectively, the first and second sets of regions having different polarisation-changing effects in the private mode.

12. A display as claimed in claim 11, in which the regions of one of the first and second sets is arranged to change the polarisation of light passing therethrough by 90° in the private mode.

13. A display as claimed in claim 12, in which the regions of the one set are arranged to operate in the twisted nematic mode during operation in the private mode.

14. A display as claimed in claim 12, in which the regions of the other of the first and second sets are arranged to have substantially no effect on the polarisation of light passing therethrough in the private mode.

15. A display as claimed in claim 14, in which the regions of the other set are arranged to operate in the electrically controlled birefringence mode during operation in the private mode.

16. A display as claimed in claim 13, in which the controllable device is arranged to operate with homeotropic alignment in the public mode.

17. A display as claimed in claim 11, in which the controllable device is of the splay-twist type and has a patterned electrode arrangement defining the regions of the first and second sets.

18. A display as claimed in claim 1, in which the display device is a liquid crystal display device.

19. A display as claimed in claim 18, in which the display device is transmissive.

20. A display as claimed in claim 19, comprising a backlight for the display device.

21. A display as claimed in claim 1, in which the display device is a light emitting diode display device.

22. A display as claimed in claim 21, in which the display device is an organic light emitting diode display device.

23. A display as claimed in claim 1, in which the third image comprises an obscuring image or sequence of images for obscuring the second image in viewing regions receiving light from the second and third images during the private mode.

24. A display as claimed in claim 15, in which the controllable device is arranged to operate with homeotropic alignment in the public mode.
